(19) United States
(12) Patent Application Publication
(10) Pub. No.: US 2012/0133977 A1
(43) Pub. Date: May 31, 2012

(54) PRINT SYSTEM, IMAGE FORMING APPARATUS, SERVER, PRINTING METHOD, AND PROGRAM

(75) Inventor: Jin Sunata, Yokohama-shi (JP)

(73) Assignee: CANON KABUSHIKI KAISHA, Tokyo (JP)

(21) Appl. No.: 13/300,484

(22) Filed: Nov. 18, 2011

(30) Foreign Application Priority Data
Nov. 25, 2010 (JP) 2010-262324

(51) Int. Cl. G06K 15/02

(52) U.S. Cl. 358/1.15

(57) ABSTRACT

An image forming apparatus determines, when information including print data and print setting information is requested of a print server in response to an instruction from an input/output device and acquired, and the acquired information is for saving printing, whether a printing result is affected in response to a remaining amount of a color material, warns a user when the printing result is affected, and requests to the print server, print data and print setting information by which the saving printing is not performed, when an instruction to cancel setting of the saving printing is issued from the user, and acquires the print data and the print setting information to perform printing.

### BACKGROUND OF THE INVENTION

1. Field of the Invention

The present invention relates to print control performed when print processing of print data acquired from a server is performed according to a request from an image forming apparatus.

2. Description of the Related Art

In recent years, a system for connecting an image forming apparatus such as a multifunction peripheral to the Internet via a network and acquiring and printing print data generated by a server application has been provided.

Further, as a convenient service, an image forming apparatus need not be specified at the time of print setting, and a printing result is obtained by making a print request from an image forming apparatus with which a user wishes to perform printing. For example, there has been a so-called pull printing in which a user causes a printer to acquire print data in Portable Document Format (PDF) format or the like by requesting the data to an external storage and print the received data.

Conventionally, these services have been mainly aimed at consumers and generally a printing result faithful to original data is obtained. However, in office use, a printing system which sacrifices a printing result to some extent has been required to save a used amount of consumables in consideration of a load on environment. The printing result is sacrificed when a print quality is deteriorated, for example, thinned characters, thinned images, and faded prints are generated. Thus, the used amount of consumables (a color material such as a toner or an ink) can be reduced.

As a conventional technique, Japanese Patent Application Laid-Open No. 2007-34846 discusses updating of the print data setting in the apparatus, when a printing apparatus inputs a setting change for print data that has been already acquired. According to this document, if the printing apparatus inputs the setting change that cannot be updated in the apparatus, a request is sent to an information processing apparatus serving as a sending source of the print data to correct the print data, and the print data that has been corrected is reacquired.

When control is performed to make a setting that sacrifices the printing result, which is a function of a server on the Internet serving as a request source of print data, the print quality may be deteriorated more than supposed, for example, the printing result becomes too light depending on a current status (e.g., a remaining amount of the color material) of the image forming apparatus serving as an output destination. In such a case, it is necessary to perform re-printing by returning the setting. As a result, the consumables may be unnecessarily wasted.

In a system for performing the pull-printing, a mechanism for avoiding unanticipated lower quality of the printing result and waste of the consumables in re-printing while realizing saving of the consumables in the image forming apparatus has been required.

### SUMMARY OF THE INVENTION

The present invention is directed to a mechanism for performing the printing flexibly in consideration of consumables saving setting when an image forming apparatus requests print the print data that is managed on the server side.

According to an aspect of the present invention, a print system comprises a server, and an image forming apparatus configured to perform print processing of print data. The server includes a storage unit configured to store data registered from an external apparatus, a generation unit configured to generate print data by processing the data to save the used amount of the color material during the print processing in the image forming apparatus, when the saving printing performed by saving the used amount of a color material is set, a first sending unit configured to send the print data generated by the generation unit to the image forming apparatus in response to a request from the image forming apparatus, and a second sending unit configured to send the data stored by the storage unit before the processing by the generation unit is performed, to the image forming apparatus again in response to a request to cancel the setting of the saving printing from the image forming apparatus. The image forming apparatus includes a first request unit configured to request to the server information including print data and print setting information in response to an instruction from an operation unit, a detection unit configured to detect a remaining amount of the color material used for the print processing in the image forming apparatus, a determination unit configured to determine whether a printing result based on the print data and the print setting information is affected according to the remaining amount of the color material detected by the detection unit, when the information acquired in response to the request from the first request unit includes at least one of print data and print setting information for the saving printing performed by saving the used amount of the color material, a print processing unit configured to perform print processing based on the print data and the print setting information included in the information acquired in response to the request from the first request unit, when the determination unit determines that the printing result is not affected, a warning unit configured to warn a user when the determination unit determines that the printing result is affected, and a second request unit configured to request to the server, print data and print setting information, by which the saving printing is not performed, when instructed to cancel the setting of the saving printing from the user after the warning by the warning unit. The print processing unit performs print processing, when it has acquired the print data and the print setting information, by which the saving printing is not performed, in response to the request from the second request unit, based on the acquired print data and print setting information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of a print system according to an exemplary embodiment of the present invention.

FIG. 2 is a block diagram illustrating an example of a hardware configuration of an image forming apparatus.

FIG. 3 is a block diagram illustrating an example of a hardware configuration of an instruction terminal, an application server, and a print server.

FIG. 4 is a block diagram illustrating an example of a software module configuration of the image forming apparatus.

FIG. 5 is a block diagram illustrating an example of a software module configuration of the print server.

FIG. 6 is a flowchart illustrating processing from acquisition to transmission of print data in a print server according to a first exemplary embodiment.

FIG. 7 is a flowchart illustrating processing from a request for print data to printing in an image forming apparatus according to the first exemplary embodiment.

FIG. 8 illustrates an example of a consumables setting screen.

FIG. 9 illustrates print data by which consumables setting has been performed.

FIG. 10 illustrates an example of a screen for warning that a printing result is unfavorably affected, for example, becomes too light when the consumables saving is set because a remaining amount of the consumables is small.

FIG. 11 is a flowchart illustrating processing from acquisition to transmission of print data in a print server according to a second exemplary embodiment.

FIG. 12 is a flowchart illustrating processing from a request for print data to printing in an image forming apparatus according to the second exemplary embodiment.

### DESCRIPTION OF THE EMBODIMENTS

Various exemplary embodiments, features, and aspects of the invention will be described in detail below with reference to the drawings.

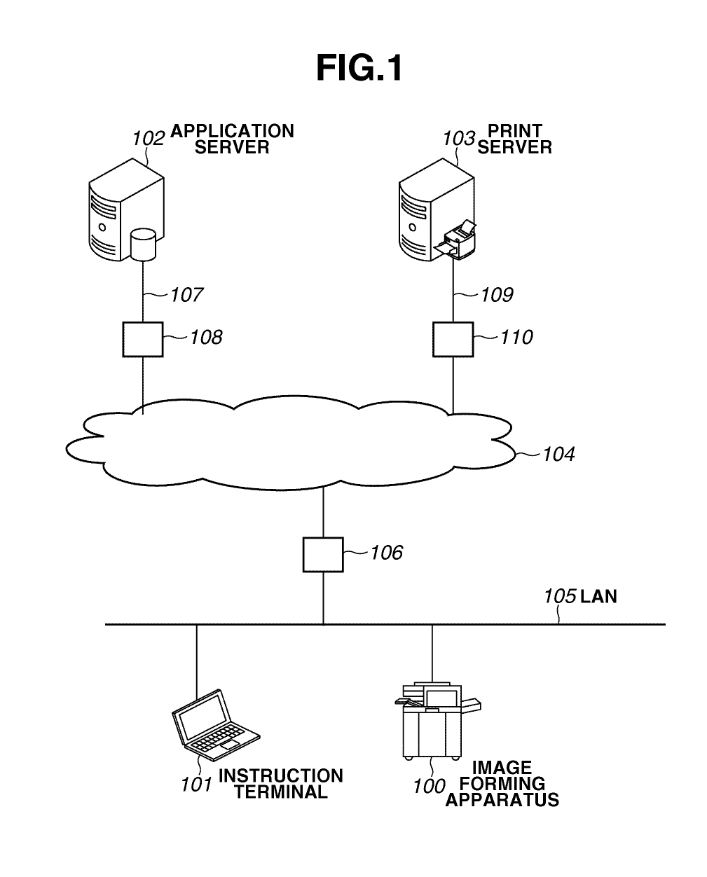

FIG. 1 is a block diagram illustrating an example of a configuration of a print system according to an exemplary embodiment of the present invention.

In a print system according to a first exemplary embodiment, an image forming apparatus 100 and an instruction terminal 101, an application server 102, and a print server 103 are connected to local area networks (LANs) 105, 107, and 109 and can communicate with each other via the LANs.

Routers 106, 108, and 110 connect to the local area networks 105, 107, and 109, and the Internet 104.

A user uploads electronic data to be printed to the application server 102 from the instruction terminal 101, to make a print request. The print server 103 is notified of the print request, and acquires the electronic data to be printed from the application server 102, to generate print data. Further, the user can perform printing by performing an operation on an operation unit in the image forming apparatus 100 and receives a print job generated by the print server 103 in the image forming apparatus 100.

The instruction terminal 101 and the image forming apparatus 100 need not be connected to the same LAN, and may be respectively connected to the application server 102 and the print server 103 via the Internet 104 from other networks. As a network configuration, the LANs 105, 107, and 109 may be the same network without passing the Internet 104.

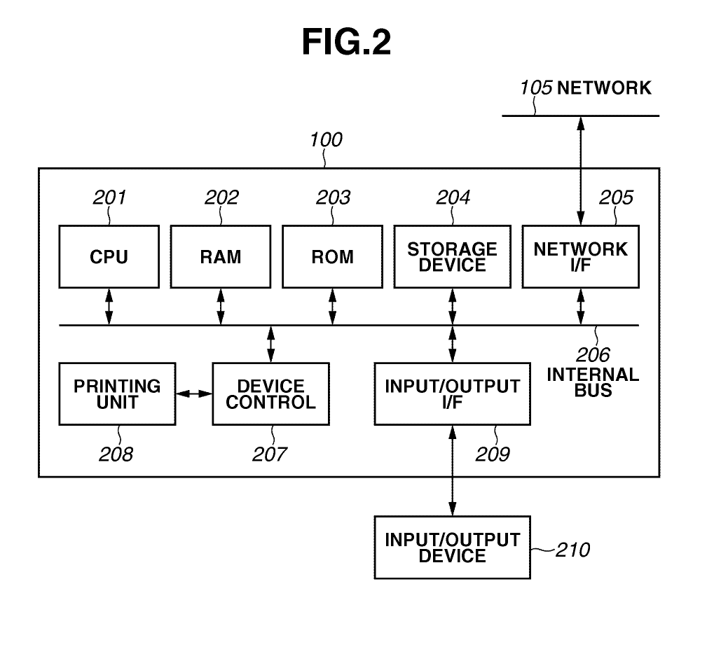

FIG. 2 is a block diagram illustrating an example of a hardware configuration of the image forming apparatus 100. The image forming apparatus 100 can be applied to various types of image forming apparatuses such as a digital multi-function peripheral, a laser beam printer, and an inkjet printer. The image forming apparatus 100 includes a central processing unit (CPU) 201, a random access memory (RAM) 202, a read-only memory (ROM) 203, a storage device 204, a network interface (network I/F) 205, an internal bus 206, a device control 207, and a printing unit 208 including a fixing device.

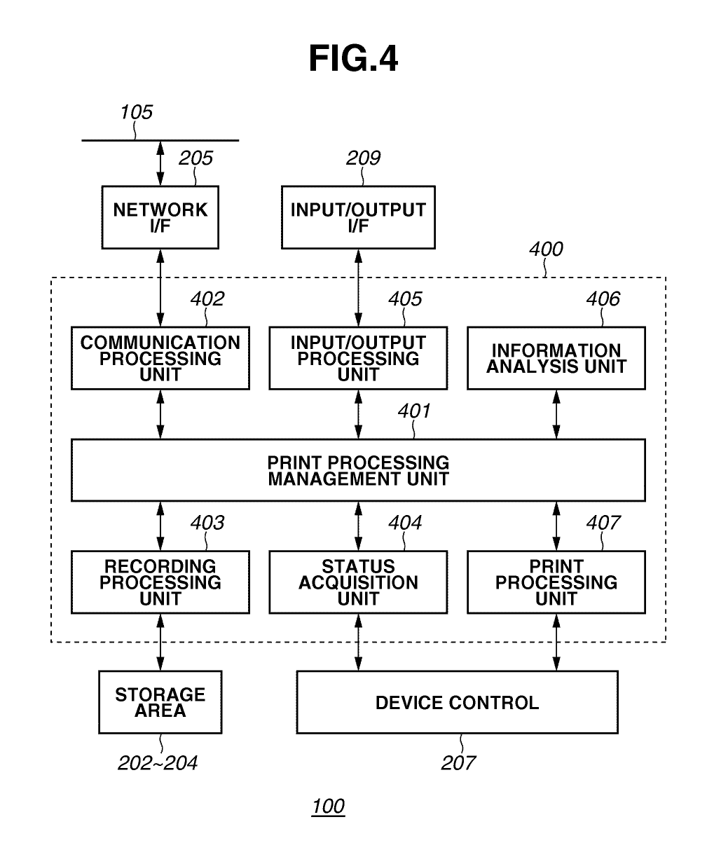

The CPU 201 includes a program (also including a program for implementing each software module illustrated in FIG. 4, described below) stored in the ROM 203, and comprehensively controls devices via the internal bus 206. The RAM 202 functions as a memory or a work area for the CPU 201.

The network interface 205 exchanges data unidirecionally or bidirectionally with an external network device or a personal computer (PC) via the LAN 105. The device control unit 207 controls the printing unit 208.

The CPU 201, together with the RAM 202 and the ROM 203, executes the program while recording electronic data and image data to be printed, which have been sent from the instruction terminal 101 and registered on a recording medium such as a storage device 204. The storage device 204 functions as an external storage device, and can also store counter information, system information, and monitoring information in place of the RAM 202 in addition to storing image data. The storage device 204 includes a hard disk drive (HDD) and a solid-state drive (SSD), for example.

As input/output interface (input/output I/F) 209 controls input/output from an input/output device 210 including a display device such as a cathode ray tube (CRT) or a liquid crystal display (LCD), a pointing device such as a touch panel, a hard key, and an authentication card reader.

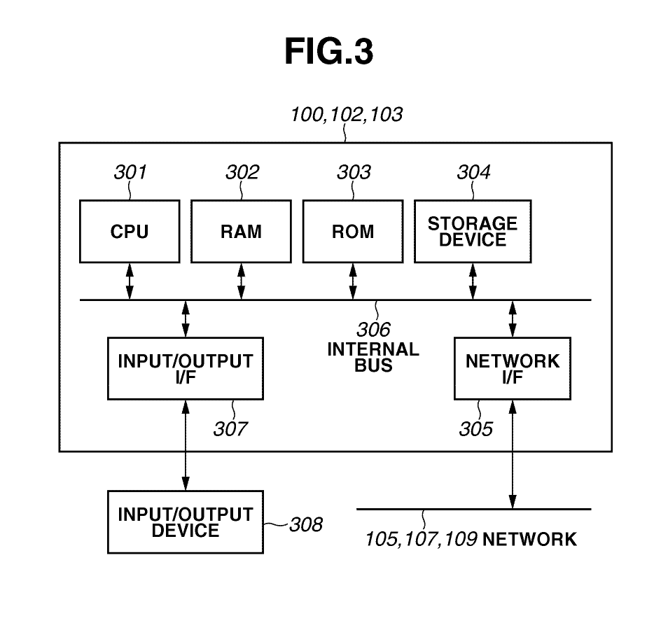

FIG. 3 is a block diagram illustrating an example of a hardware configuration of each of the instruction terminal 101, the application server 102, and the print server 103.

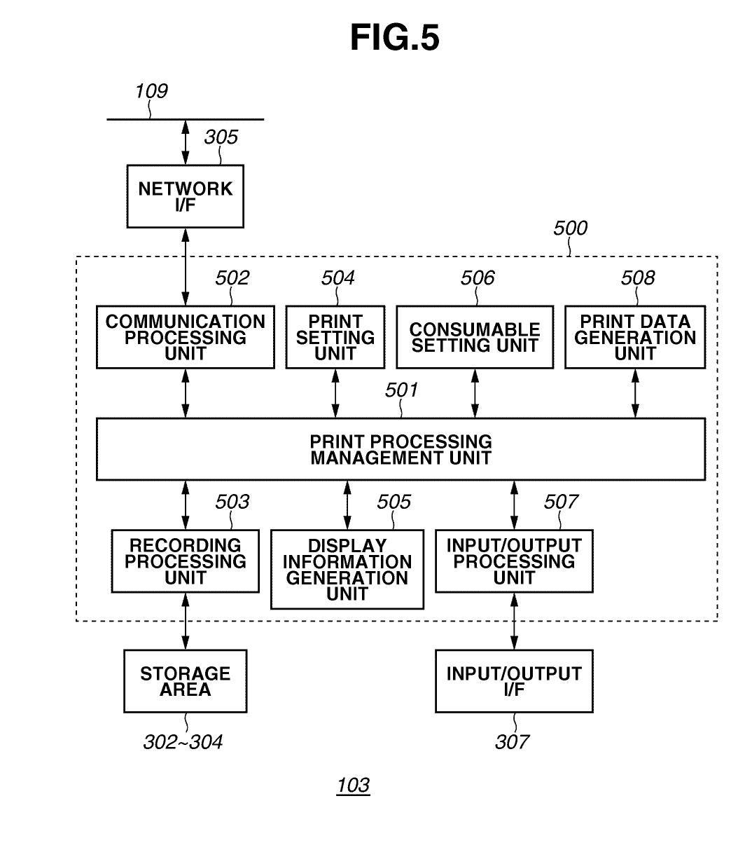

In FIG. 3, a CPU 301 executes a program, which has been computer-readably recorded on a ROM 303 or a storage device 304, and comprehensively controls devices via an internal bus 306. The print server 103 includes also a program for implementing each software module illustrated in FIG. 5, as described below.

The devices such as a RAM 302, the ROM 303, the storage device 304, and a network interface (network I/F) 305 are connected to the internal bus 306. Each of the instruction terminal 101, the application server 102, and the print server 103 includes an input/output I/F 307, e.g., Play Station 2 (PS2), a Universal Serial Bus (USB) interface, and an analog or digital display interface.

An input/output device 308 such as a keyboard, a pointing device (e.g., a mouse or a touch panel), a CRT, or a liquid crystal device can be connected to the instruction terminal 101, the application server 102, or the print server 103 via the input/output interface 307, and can register and set management information and refer to processing information.

The network interface 305 is connected to the Internet 104 via the LAN 105, 107, or 109 or the gateway device 106, 108, or 110. The print server 103 can communicate with the external image forming apparatus 100, the instruction terminal 101, and the application server 102 via the network interface 305. Each of the gateway devices 106, 108, and 110 includes a router, a proxy server, and a firewall.

The CPU 301, together with the RAM 302 and the ROM 303, executes a program while recording image data on a recording medium such as the storage device 304. The storage device 304 functions as an external storage device, and can also store system information and processing information in place of the RAM 302. In the print server 103, the storage device 304 also stores electronic data to be printed, print data generated from the electronic data, and management information relating to the image forming apparatus 100.

While the input/output device 308 has been described as an external device, it may be contained as hardware in the instruction terminal 101, the application server 102, or the print server 103.

FIG. 4 is a block diagram illustrating an example of a software module configuration of the image forming apparatus 100. The same units as those illustrated in FIG. 2 are assigned the same reference numerals.

In FIG. 4, an entire software module 400 in the image forming apparatus 100 processes an operational status of the image forming apparatus 100. The software module 400 is substantialized when the CPU 201 in the image forming apparatus 100 rasterizes a program, which has been computer-readably recorded on the ROM 203, into the RAM 202 and executes the program. The software module 400 includes software modules 401 to 407. Each of the software modules 401 to 407 will be described below.

The print processing management unit 401 can communicate with another device by connecting to the network interface 205 and the network 105 via the communication processing unit 402. The communication processing unit 402 sends notification information to the print server 103 and conversely receives print setting information and print data from the print server 103 according to an instruction from the print processing management unit 401.

The recording processing unit 403 exchanges information with recording areas in the RAM 202, the ROM 203, and the storage device 204. The recording processing unit 403 records information processed by the print processing management unit 401 on the storage device 204, and acquires setting information stored in the ROM 203.

The status acquisition unit 404 acquires a processing status of a job and failure information in addition to a counter representing a remaining amount of a consumables and the number of used sheets, and a component counter representing a use status of a component, and a function counter representing other use status from the device control 207. The print processing management unit 401 can acquire an operational status of a device and the above-mentioned information via the status acquisition unit 404, as needed.

The print processing management unit 401 can also handle information, which can be acquired by the recording processing unit 403, as communication data. The print processing management unit 401 also sends, when it sends the information to the print server 103, information specific to the image forming apparatus 100 or setting information (an internet protocol (IP) address, a media access control (MAC) address, a device serial number, a product name, a product type, etc.). Thus, the print server 103 can perform determination and individual processing for each image forming apparatus.

The input/output processing unit 405 is an interface for controlling a hard key, a display, and a pointing device (e.g., a touch panel) serving as the input/output device 210 and confirming a setting and a status of the image forming apparatus 100.

An information analysis unit 406 can analyze print setting information and print data, which are acquired from the print server 103 connected thereto via the communication processing unit 402 and the network interface 205. The print processing management unit 401 transfers the print setting information and the print data, which have been analyzed by the information analysis unit 406, to the print processing unit 407. The print processing unit 407 can control the device control 207 using the print setting information and the print data, which have been analyzed by the information analysis unit 406, transferred from the print processing management unit 401, to perform printing. The print setting information to be analyzed by the information analysis unit 406 may be in any format that is previously defined as the print server 103, and can use an Extensible Markup Language (XNL) and a unique format.

FIG. 5 is a block diagram illustrating an example of a software module configuration of the print server 103. The same units as those illustrated in FIG. 3 are assigned the same reference numerals.

In FIG. 5, a software module 500 in the print server 103 is substantialized when the CPU 301 in the print server 103 rasterizes a program, which has been computer-readably recorded on the ROM 303 or the storage device 304, into the RAM 302 and executes the program. The software module 500 includes software modules 501 to 508. Each of the software modules 501 to 508 will be described below.

The print processing management unit 501 is a processing unit for determining, processing, and recording notification information that is notified from the image forming apparatus 100 and sending print setting information and print data to the image forming apparatus 100. The print processing management unit 501 controls the communication processing unit 502, the recording processing unit 503, the print setting unit 504, the display information generation unit 505, the consumables setting unit 506, the input/output processing unit 507, and the print data generation unit 508.

The communication processing unit 502 can connect to the network 109 via the network interface 305 and receive a notification and a request from the image forming apparatus 100, the instruction terminal 101, and the application server 102.

The communication processing unit 502 receives information and an instruction from the print processing management unit 501, and sends or receives communication data based on a predetermined communication processing specification to or from the instruction terminal 101 or the image forming apparatus 100. The communication processing unit 502 stores the above-mentioned processed information and instruction as a history in the RAM 302 or the storage device 304 via the recording processing unit 503. The print setting unit 504 or the consumables setting unit 506 history-searches the information stored in the RAM 302 or the storage device 304, the display information generation unit 505 converts the information into information that can be displayed, and the instruction terminal 101 or the like can refer to the information.

The print setting unit 504 notifies the display information generation unit 505 of information for generating a screen for setting information required in designating and printing data to be printed from the instruction terminal 101 in response to the instruction from the print processing management unit 501.

The consumables setting unit 506 notifies the display information generation unit 505 of information for generating a screen for setting the consumables (for setting for performing control to limit a used amount of consumables in generating print data) from the instruction terminal 101 in response to the instruction from the print processing management unit 501. The print setting unit 504 may include the consumables setting unit 506.

The display information generation unit 505 generates information required for print setting and setting of a used amount of the consumables, and display information for receiving an instruction, using a Hypertext Markup Language (HTML) format, for the instruction terminal 101. Not only the HTML format but also another format that matches a display device can be prepared. The communication processing unit 502 is provided with a function of a World Wide Web (WWW) server to enable the display of the information and the reception of the instruction using the HTML format.

The print processing management unit 501 causes the print data generation unit 508 to generate print setting information and print data in response to the received instruction of the display information generated by the display information generation unit 505, and stores the print setting information and the print data in the RAM 302 or the storage device 304 via the recording processing unit 503. When the used amount of the consumables is set, the print data generation unit 508 generates print data and print setting information considering the used amount of the consumables.

The print processing management unit 501 can send the print setting information and the print data, which have been generated by the print data generation unit 508, to the image forming apparatus 100 via the communication processing unit 502 according to the request from the image forming apparatus 100. The print processing management unit 501 also enables the print data generation unit 508 to generate different print setting information and print data according to the request from the image forming apparatus 100, and can send the generated print setting information and print data.

The input/output processing unit 507 is an interface for controlling a keyboard, a pointing device (e.g., a mouse or a touch panel), and a display serving as the input/output device 308, and confirming and managing setting and a status of the print server 103. The input/output processing unit 507 converts, which it displays information on the display serving as the input/output device 308, a format of the information into a format that can be displayed via the input/output processing unit 507.

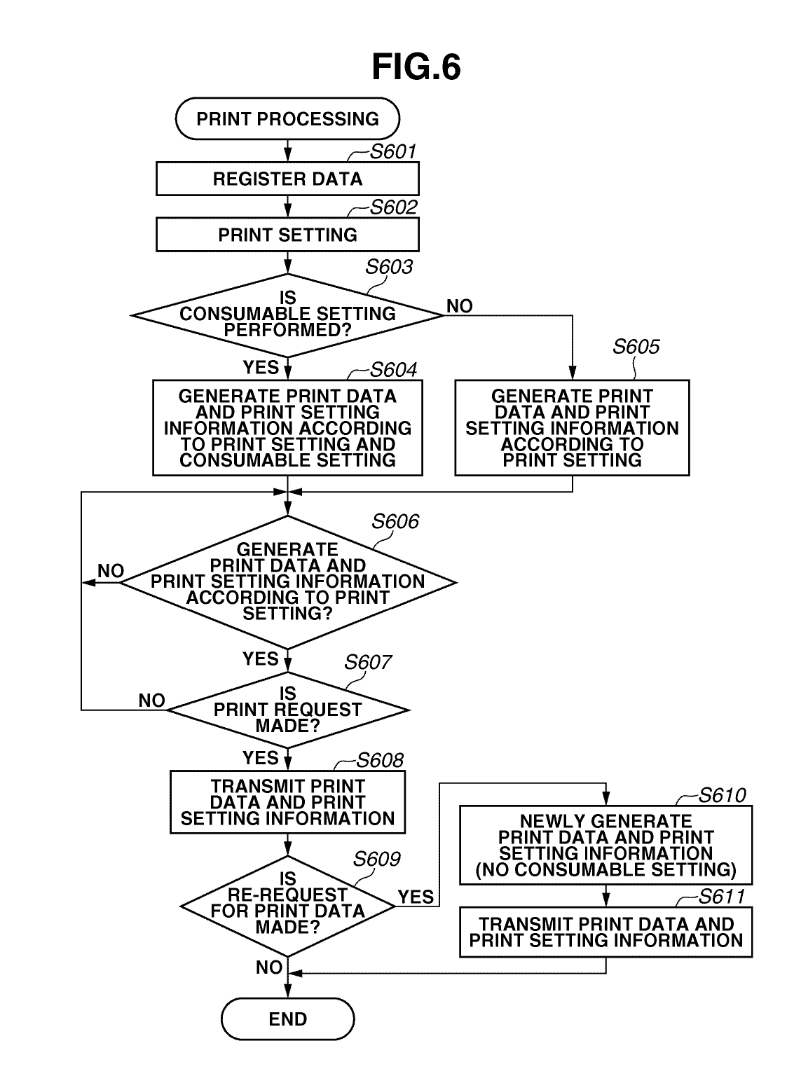

A flow of processing for instructing the print server 103 to make a print request from the image forming apparatus 100, acquiring print setting information and print data, and performing printing with reference to FIGS. 6 to 10.

FIG. 6 is a flowchart illustrating processing from acquisition to transmission of print data in the print server 103 according to the first exemplary embodiment. The software module 500 performs the processing in the flowchart. More specifically, the processing is implemented when the CPU 301 in the print server 103 rasterizes a program, which has been computer-readably recorded on the ROM 303 or the storage device 304, into the RAM 302 and performs the rasterized program.

First, a user ups electronic data to be printed to the application server 102 from the instruction terminal 101. The print processing management unit 501 in the print server 103 starts the processing in the flowchart in response to a notification in this case.

In step S601, the print processing management unit 501 acquires, based on a registration request and a print request for electronic data from the instruction terminal 101, the electronic data to be registered, which has been designated in response to the request, from the application server 102, and registers the acquired electronic data in the storage device 304, and the processing proceeds to step S602. The registered electronic data may be scan data in the image forming apparatus 100. In this case, the registration request for the data can also be directly made from the image forming apparatus 100.

In step S602, the print processing management unit 501 provides a screen for performing print setting for the electronic data, which has been registered in step S601, to the user. The user can perform setting during printing in the image forming apparatus 100, as needed. Details of the setting will be described below. The print processing management unit 501 first sends a screen for performing setting required for printing (a print setting screen (not illustrated)) to the instruction terminal 101 using the print setting unit 504, the consumables setting unit 506, and the display information generation unit 505. At the instruction terminal 101, the sent screen (print setting screen) is displayed. The user performs print setting on the screen.

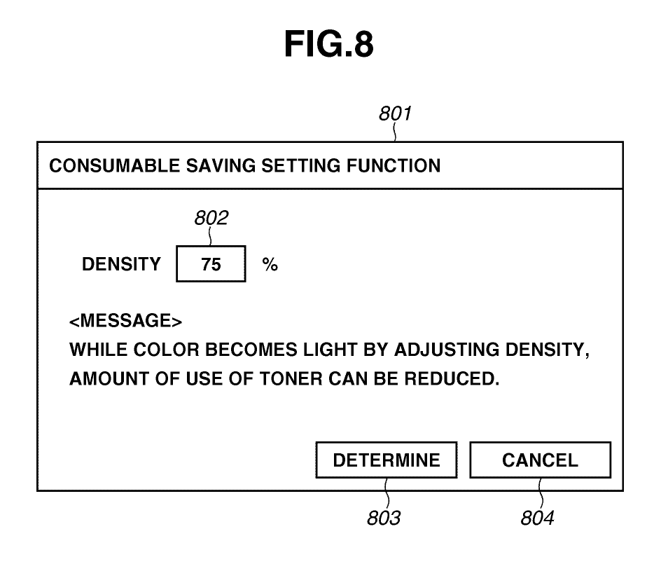

The print processing management unit 501 then sends a screen for performing detailed setting of consumables setting (setting for performing control to save a used amount of consumables during printing), i.e., a consumables setting screen illustrated in FIG. 8 to the instruction terminal 101, as needed. At the instruction terminal 101, the sent screen (consumables setting screen) is displayed. The user sets the used amount of the consumables on the screen. Then, print setting including the consumables setting or the like is returned to the print server 103.

An example of the consumables setting screen will be described with reference to FIG. 8. The consumables setting screen 801 illustrated in FIG. 8 includes a density setting field 802, a determination button 803 for determining a value input to the density setting field 802, and a cancel button 804 for ending the consumables setting screen 801 without performing setting. The consumables setting can be performed by determining a value in the density setting field 802 from an input/output device in the instruction terminal 101 and clicking the determination button 803. The print setting and the detailed setting of the consumables setting may be performed on one screen (in one step).

In step S603, the print processing management unit 501 determines, when it receives a reply from the instruction terminal 101, whether the above-mentioned consumables setting has been performed as the print setting from a content of the reply. If the print processing management unit 501 determines that the consumables setting has been performed (YES in step S603), the processing proceeds to step S604. In step S604, the print processing management unit 501 instructs the print data generation unit 508 to generate print data and print setting information according to the print setting and the consumables setting, and the processing proceeds to step S606. In response to the instruction in step S604, the print data generation unit 508 processes the electronic data registered in the storage device 304 to save a used amount of a color material during the printing in the image forming apparatus 100, to generate print data by which the used amount of consumables can be saved.

On the other hand, if the print processing management unit 501 determines that the consumables setting has not been performed (NO in step S603), the processing proceeds to step S605. In step S605, the print processing management unit 501 instructs the print data generation unit 508 to generate print data and print setting information according to the print setting, and the processing proceeds to step S606. In response to the instruction in step S605, the print data generation unit 508 generates the print data according to the print setting. The print setting information generated in response to the instructions in steps S604 and S605 may include information representing the presence or non-presence of the consumables setting and information representing a density value (a value set in the density setting field S802 illustrated in FIG. 8) in the consumables setting. If the electronic data to be printed, which has been registered from the instruction terminal 101, is data having a PDF format or the like, original data, which has been registered as the print data, is directly used in step S605.

In step S606, the print processing management unit 501 waits for an authentication request from the image forming apparatus 100. The print processing management unit 501 performs, when it receives the authentication request from the image forming apparatus 100, authentication, and determines whether authentication is successfully performed. If the authentication has been unsuccessfully performed (NO in step S606), the processing returns to step S606. In step S606, the print processing management unit 501 waits for the subsequent authentication request. If a user has not been registered yet or if an expiration date has passed, the authentication may also have been unsuccessfully performed.

If the authentication has been successfully performed (YES in step S606), the processing proceeds to step S607. In step S607, the print processing management unit 501 confirms whether a print request is made from the image forming apparatus 100. If the print processing management unit 501 determines that the print request has not been made (NO in step S607), the processing returns to step S606. In step S606, the print processing management unit 501 waits for the subsequent authentication request.

On the other hand, if the print processing management unit 501 determines that the print request has been made (YES in step S607), the processing proceeds to step S608. In step S608, the print processing management unit 501 sends (transmits) the print data and the print setting information to the image forming apparatus 100 that has made the print request via the communication processing unit 502 (first sending processing).

If the print processing management unit 501 receives a request for printing-related information from the image forming apparatus 100 after the authentication has been successfully performed in step S606 and before the print request is received in step S607, the print processing management unit 501 information relating to print data corresponding to the user who has performed the authentication in step S606 (e.g., a list of print data) to the image forming apparatus 100. This processing is not illustrated in FIG. 6.

In step S609, the print processing management unit 501 then determines whether a re-request for print data is made from the image forming apparatus 100 that has transmitted the print data and the print setting information. If the print processing management unit 501 determines that the re-request for the print data has not been made (for example, the re-request has not been made within a predetermined period of time, or a notification that printing is completed has been made) (NO in step S609), the processing ends.

On the other hand, if the print processing management unit 501 determines that the re-request for the print data has been made (YES in step S609), the processing proceeds to step S610. In step S610, the print processing management unit 501 causes the print data generation unit 508 to newly generate print data and print setting information according to the request. If the electronic data to be printed, which has been registered from the instruction terminal 101, has a PDF format or the like, original data (i.e., data before the processing in step S604 is performed), which has been registered as the print data, is directly used in step S610.

In step S611, the print processing management unit 501 sends the print data and the print setting information, which have been generated in step S610, to the image forming apparatus 100 again (second sending processing), and the processing ends.

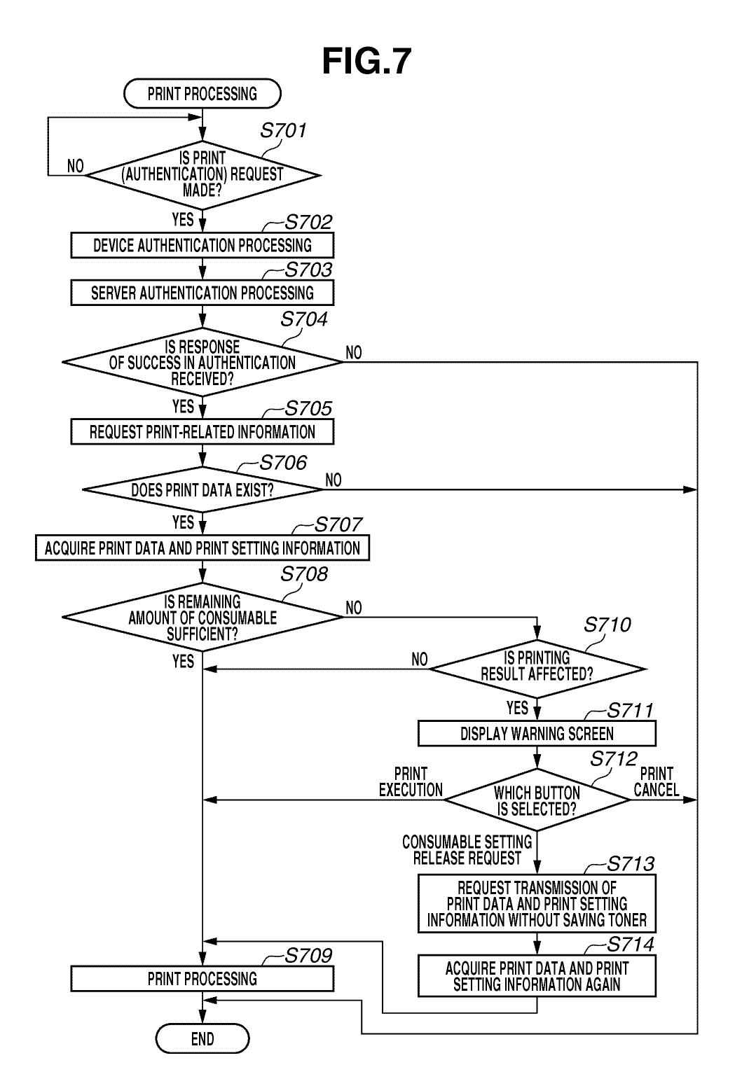

A flow of processing from a request for print data to printing in the image forming apparatus 100 according to the first exemplary embodiment will be described below with reference to FIG. 7. FIG. 7 is a flowchart illustrating the processing from the request for the print data to the printing in the image forming apparatus 100 according to the first exemplary embodiment. The software module 400 performs the processing in the flowchart. More specifically, the processing is implemented when the CPU 201 in the image forming apparatus 100 rasterizes a program, which has been computer-readably recorded on the ROM 203 or the storage device 204, into the RAM 202 and executes the rasterized program.

In step S701, the print processing management unit 401 in the image forming apparatus 100 waits for a print request (authentication request) from a user, and determines whether the authentication request is made. The input/output device 210 includes an authentication card reader. The user can make the authentication request by holding an authentication card (an integrated circuit (IC) card) over the input/output device 210. Authentication may be performed by not only holding the authentication card over the input/output device 210 but also inputting a user identification (ID) or a password using a key (a soft key or a hard key) prepared for the input/output device 210.

If the print processing management unit 401 determines that the authentication request has been made (YES in step S701), the processing proceeds to step S702. In step S702, the print processing management unit 401 performs device authentication processing. Authentication is performed using authentication information, which has been registered in the image forming apparatus 100 itself.

In step S703, the print processing management unit 401 then performs authentication (server authentication processing) by transferring authentication information read from the authentication card or keyed authentication information to request authentication, to the print server 103 via the communication processing unit 402.

In step S704, the print processing management unit 401 then receives an authentication processing result in the print server 103, and determines whether it has received a response of success in authentication. If the print processing management unit 401 determines that it has received a response of failure in authentication from the print server 103 (NO in step S704), the print processing management unit 401 determines that the print server 103 cannot be used, and the processing ends. On the other hand, if the print processing management unit 401 determines that it has received the response of success in authentication from the print server 103 (YES in step S704), the processing proceeds to step S705.

In step S705, the print processing management unit 401 performs processing for requesting printing-related information from the print server 103, and the processing proceeds to step S706. In step S706, the print processing management unit 401 acquires printing-related information (e.g., a list of print data) corresponding to the user who has performed the authentication in step S703 from the print server 103, and determines whether printing-related data exists in the print server 103.

If the print processing management unit 401 determines that the printing-related data does not exist in the print server 103 (NO in step S706), the processing ends. A case where there is no printing-related data means that a printing instruction is not issued from the instruction terminal 101 or there exists no print data in the printer server 103 as a result of performing print processing in another image forming apparatus after a printing instruction.

On the other hand, if the print processing management unit 401 determines that the printing-related data exists in the print server 103 (YES in step S706), the processing proceeds to step S707. In step S707, the print processing management unit 401 makes a print request to the print server 103, to acquire print data and print setting information from the print server 103 (first request processing). The acquired print data and print setting information are analyzed in the information analysis unit 406 to perform setting required for printing, and are subjected to rasterization processing, as needed. In step S707, all print data corresponding to the user who has successfully performed the authentication in steps S703 and S704 may be received, or only the print data designated from the image forming apparatus 100 may be received.

In step S708, the print processing management unit 401 then causes the status acquisition unit 404 to acquire a status of the printing unit 208 via the device control 207. Information to be acquired includes a detection result of a remaining amount of a color material, such as an ink or a toner used for the print processing. The print processing management unit 401 determines whether a remaining amount of consumables (a color material such as a toner) is sufficient from the acquired status of the printing unit 208. For example, in the present exemplary embodiment, the print processing management unit 401 determines that the remaining amount of the consumables is not sufficient if it is less than a first remaining amount determination value (e.g., 10%), and determines that the remaining amount of the consumables is sufficient if it is the first remaining amount determination value or more.

If the print processing management unit 401 determines that the remaining amount of the consumables is sufficient (YES in step S708), the processing proceeds to step S709. In step S709, the print processing management unit 401 instructs the print processing unit 407 to perform printing based on the print data and the print setting information, which have been acquired in step S708, to perform the printing.

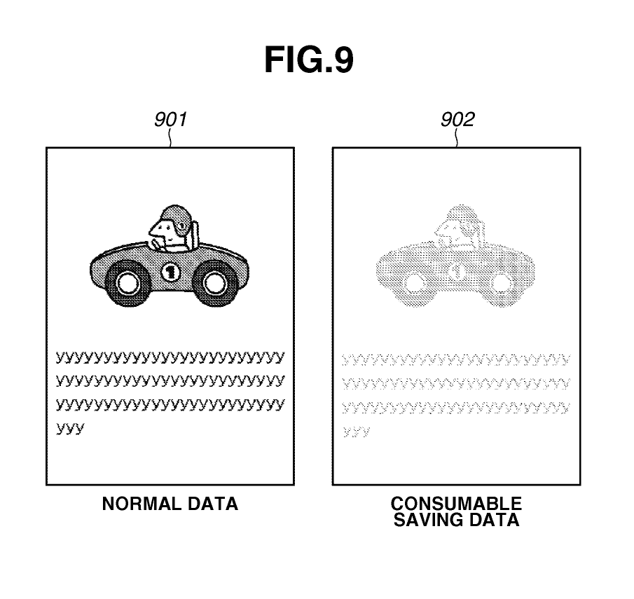

On the other hand, if the print processing management unit 401 determines that the remaining amount of the consumables is not sufficient (NO in step S708), the processing proceeds to step S710. In step S701, the print processing management unit 401 determines whether a printing result is affected. A case where printing is affected will be described with reference to FIG. 9.

FIG. 9 illustrates print data processed and generated according to consumables setting. In FIG. 9, processed data (the data which can save the used amount of consumables) 902 is lighter (lower in density) as a whole than original data 901. This is implemented by making a color itself of the original data 901 lighter as a whole or thinning some of pixels. The used amount of the consumables can be saved by using the processed data 902. On the other hand, if the remaining amount of the consumables in the image forming apparatus 100 is small, a printing result may be too light.

A determination method in step S710 illustrated in FIG. 7 will be described below by taking examples (1) to (4).

(1) If the printing setting information acquired in step S707 includes information representing the presence or non-presence of consumables setting, for example, determination is made, as described below. In this configuration, the print processing management unit 401 determines that “printing is affected” if the consumables setting included in the print setting information indicates the presence, and determines that “printing is not affected” if the consumables setting included in the print setting information indicates the non-presence.

(2) If the print setting information acquired in step S707 includes information representing a density value (a value set in the density setting field 802 illustrated in FIG. 8) in the consumables setting, for example, determination is made, as described below. In this configuration, the print processing management unit 401 determines that “printing is affected” if the density value in the consumables setting included in the print setting information is less than a predetermined set value (e.g., 50%), and determines that “printing is not affected” if it is the predetermined set value or more.

(3) The determination may be made only depending on a remaining amount of consumables. For example, the print processing management unit 401 determines that “printing is affected” if the remaining amount of the consumable is less than a second remaining amount determination value (e.g., 5%), which is lower than the first remaining amount determination value, and determines that “printing is not affected” if it is the second remaining amount determination value or more.

(4) The print processing management unit 401 may determine whether “printing is affected” or “printing is not affected” with reference to the print data acquired in step S707. For example, the print processing management unit 401 calculates an average value of a density of an image to be printed from the print data acquired in step S707. If the average value of the density is below a predetermined density (e.g., an intermediate value of the density), the image may become too light. Therefore, the print processing management unit 401 determines that “printing is affected”. On the other hand, if the average value of the density is the predetermined density value or more, the print processing management unit 401 determines that “printing is not affected”. The intermediate value of the density is 128 if the width of the density is 0 to 256. For example, the print processing management unit 401 may determine that “printing is affected” if an image area having a density that is less than the intermediate value of the density accounts for a predetermined percentage (e.g., 30%) of the whole area, and determine that “printing is not affected” if the image area having the density that is less than the intermediate value of the density accounts for the predetermined percentage or more of the whole area.

The above-mentioned items (1) to (4) are examples of the determination method in step S710 illustrated in FIG. 7. Any determination method may be used as long as an effect on a printing result can be determined when the remaining amount of the consumable is small.

If the print processing management unit 401 determines that the printing result is not affected (NO in step S710), the processing proceeds to step S709. In step 709, the print processing management unit 401 instructs the print processing unit 407 to perform printing based on the print data and the print setting information, which have been acquired in step S708.

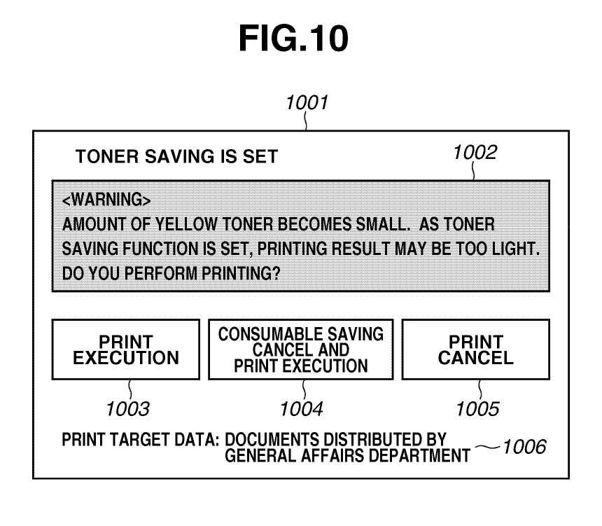

On the other hand, if the print processing management unit 401 determines that the printing result is affected (YES in step S710), the processing proceeds to step S711. In step S711, the print processing management unit 401 displays a warning screen 1001 as illustrated in FIG. 10 on a display unit in the input/output device 210 via the input/output processing unit 405, and warns that the printing result is affected, for example, becomes too light if it continuously performs printing. The warning screen 1001 will be described with reference to FIG. 10.

FIG. 10 illustrates an example of a screen for warning that a printing result may be affected, for example, become too light when consumables are subjected to saving because a remaining amount of the consumable is small. The warning screen 1001 illustrated in FIG. 10 includes a warning display field 1002, a print execution button 1003, a consumables setting cancel button 1004, a print cancel button 1005, and a print target data name button 1006.

In the warning display field 1002, a warning message for notifying a user that a printing result becomes too light when printing is continuously performed is displayed, to urge the user to select each of the print execution button 1003, the consumables setting cancel button 1004, and the print cancel button 1005.

The print execution button 1003 is selected when printing is continuously performed. The consumables setting cancel button 1004 is selected when consumables setting is cancelled in performing printing. The print cancel button 1005 is selected when printing is canceled. The print target data name button 1006 represents a name of electronic data to be printed. More specifically, on the warning screen 1001, a warning is issued that a printing result may be affected when saving printing is performed, and an instruction is given urging the user to select whether saving printing is cancelled or saving printing is performed.

Returning to the flowchart illustrated in FIG. 7, if the user who has made a print request receives the warning in step S710 and selects any one of the buttons 1003 to 1005, the processing proceeds to step S712. In step S712, the print processing management unit 401 determines which of the buttons is selected.

If the print processing management unit 401 determines that the print execution button 1003 has been selected in step S712, the processing proceeds to step S709. In step S709, the print processing management unit 401 instructs the print processing unit 407 to perform printing based on the print data and the print setting information, which have been acquired in step S707.

If the print processing management unit 401 determines that the consumables setting cancel button 1004 has been selected in step S712, the processing proceeds to step S713. In step S713, the print processing management unit 401 requests print data and print setting information, by which consumables setting has been cancelled, of the print server 103 (second request processing), and the processing proceeds to step S714.

In step S714, the print processing management unit 401 receives (acquires) the print data and the print setting information, by which the consumables setting has been cancelled, from the print server 103. In step S709, the print processing management unit 401 further instructs the print processing unit 407 to perform printing based on the print data and the print setting information, which have been acquired in step S714. If the print processing management unit 401 determines that the print cancel button 1005 has been selected in step S712, the processing ends.

As described above, in the first exemplary embodiment, if consumables saving printing is performed, appropriate print data is transmitted from the print server 103 in response to a status of consumables in the image forming apparatus 100, to perform printing. According to this configuration, even if the consumables saving printing is requested while a remaining amount of the consumables in the image forming apparatus 100 is small, an effect on printing that an image becomes too light, for example, due to a shortage of the consumables, can be suppressed.

FIG. 7 illustrates a configuration in which the remaining amount of the consumables (color material) is confirmed in step S708, and it is determined whether printing is affected in step S710 if the remaining amount of the consumables is not sufficient. However, if the print data and the print setting information, which have been acquired in step S707, are for saving printing, the remaining amount of the color material may be confirmed, to determine whether the printing result based on the print data and the print setting information is affected depending on the remaining amount of the color material.

A second exemplary embodiment differs from the first exemplary embodiment in that transmission of print data and print setting information in a print server 103 is switched depending on the presence or non-presence of a function that complies with consumables setting in an image forming apparatus 100.

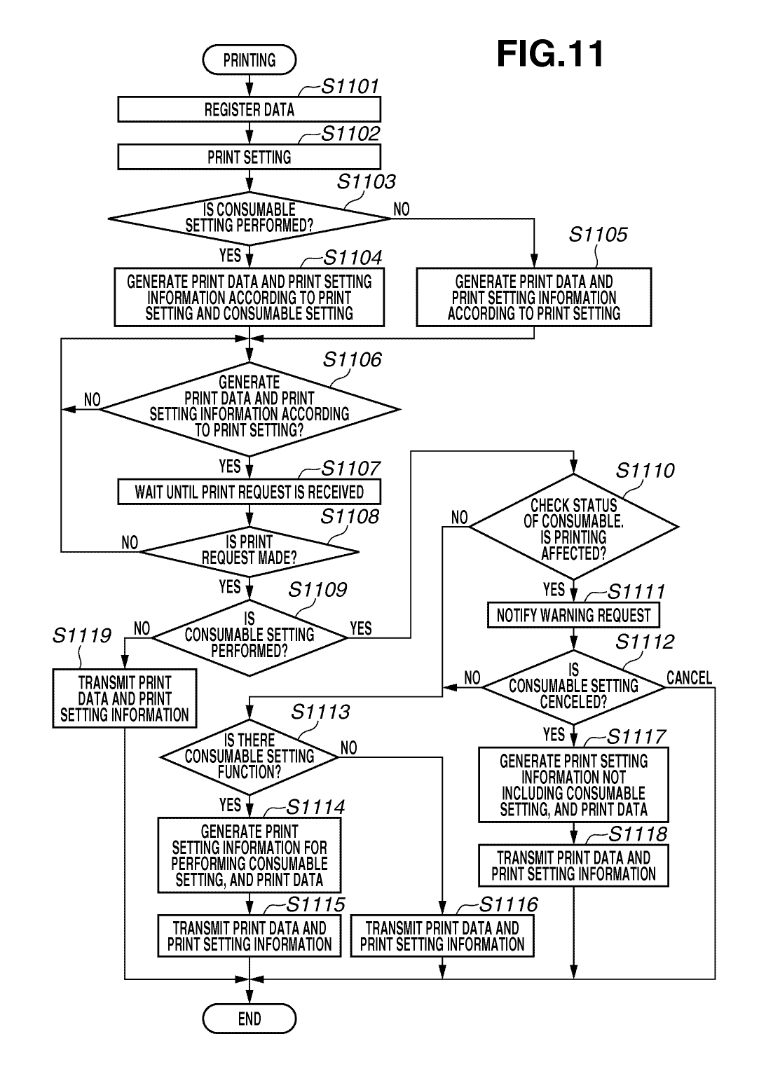

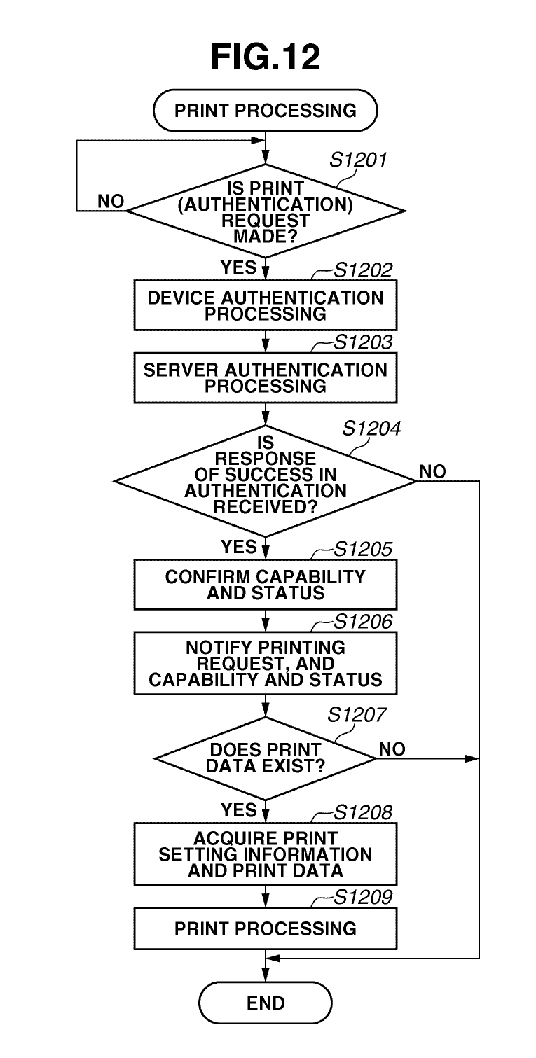

A flow and a mechanism for requesting printing to the print server 103 from the image forming apparatus 100, performing print setting, acquiring print data, and performing printing will be described below with reference to FIGS. 11 and 12.

FIG. 11 is a flowchart illustrating processing from registration to transmission of print data in the print server 103 according to the second exemplary embodiment. A software module 500 performs the processing in the flowchart. More specifically, the processing is implemented when a CPU 301 in the print server 103 rasterizes a program, which has been computer-readably recorded on a ROM 303 or a storage device 304, into a RAM 302 and executes the program.

In step S1101, a print processing management unit 501 acquires, based on a registration request and a print request of electronic data from an instruction terminal 101, the electronic data to be registered, which has been designated in the request, from an application server 102, and registers the acquired electronic data in a storage device 304 (similar to step S601 illustrated in FIG. 6).

In step S1102, the print processing management unit 501 performs print setting for the electronic data, which has been registered in step S1101 (similar to step S602 illustrated in FIG. 6). In step S1103, the print processing management unit 501 determines whether consumables setting is performed in the print setting (similar to step S603 illustrated in FIG. 6). If the print processing management unit 501 determines that the consumables setting has been performed (YES in step S1103), the processing proceeds to step S1104. In step S1104, the print processing management unit 501 instructs a print data generation unit 508 to generate print data and print setting information according to the print setting and the consumables setting, and the processing proceeds to step S1106. In response to the instruction, the print data generation unit 508 generates print data which can save a used amount of consumables according to the consumables setting.

On the other hand, if the print processing management unit 501 determines that the consumables setting has not been performed (NO in step S1103), the processing proceeds to step S1105. In step S1105, the print processing management unit 501 instructs the print data generation unit 508 to generate print data and print setting information according to the print setting, and the processing proceeds to step S1106. If the registered electronic data is data having a PDF format or the like, the print setting information is only generated, and registered original electronic data is directly used as print data.

In step S1106, the print processing management unit 501 waits for an authentication request from the image forming apparatus 100. The print processing management unit 501 performs, when it receives the authentication request from the image forming apparatus 100, authentication, and determines whether authentication is successfully performed. If the authentication has been unsuccessfully performed (NO in step S1106), the processing returns to step S1106. In step S1106, the print processing management unit 501 waits for the subsequent authentication request. If a user has not been registered yet and if an expiration date has passed, the authentication is also considered to have been unsuccessfully performed.

If the authentication has been successfully performed (YES in step S1106), the processing proceeds to step S1107. In step S1107, the print processing management unit 501 waits until a print request notified from the image forming apparatus 100 is received. In the present exemplary embodiment, both capability information and status information relating to the image forming apparatus 100 are received.

In step S1108, the print processing management unit 501 then confirms whether a print request is made. If the print processing management unit 501 determines that the print request has not been made (NO in step S1108), the processing returns to step S1106. In step S1106, the print processing management unit 501 waits for the subsequent authentication request. On the other hand, if the print processing management unit 501 determines that the print request has been made (YES in step S1108), the processing proceeds to step S1109.

In step S1109, the print processing management unit 501 confirms whether consumables setting is performed for data to be printed, which has been designated in the print request. If the print processing management unit 501 determines that the consumables setting has not been performed (NO in step S1109), the processing proceeds to step S1119. In step S1119, the print processing management unit 501 sends the print data and the print setting information, which have been generated in step S1105, to the image forming apparatus 100 to which the print request has been made via a communication processing unit 502, and the processing ends.

On the other hand, if the print processing management unit 501 determines that the consumables setting has been performed (YES in step S1109), the processing proceeds to step S1110. In step S1110, the print processing management unit 501 checks a status of a consumables from the status information relating to the image forming apparatus 100, which has been received in step S1107, and determines whether a printing result is affected when printing is performed with the consumables setting because a remaining amount of the consumables is small. For example, in the present exemplary embodiment, the print processing management unit 501 determines that the remaining amount of the consumables is not sufficient so that the printing result is affected if a remaining amount of a color material such as a toner is less than a predetermined amount (e.g., 10%), and the remaining amount of the consumables is sufficient so that the printing result is not affected if it is the predetermined amount or more.

If the print processing management unit 501 determines that the printing result is not affected (NO in step S1110), the processing proceeds to step S1113. On the other hand, if the print processing management unit 501 determines that the printing is affected (YES in step S1110), the processing proceeds to step S1111. In step S1111, the print processing management unit 501 sends a warning request to the image forming apparatus 100 via the communication processing unit 502, and the processing proceeds to step S1112. The image forming apparatus 100 displays a warning screen 1001 as illustrated in FIG. 10 in response to the warning request, receives a selection instruction (selection of the buttons 1003 to 1005) from the user, and returns a selection result from the user to the print server 103 as a response.

In step S1112, the print processing management unit 501 then receives a response to the warning request sent by the image forming apparatus 100, and determines whether the consumables setting is cancelled. If the print processing management unit 501 determines that the consumables setting is not cancelled (NO in step S1112), the processing proceeds to step S1113.

In step S1113, the print processing management unit 501 determines, for example, whether the image forming apparatus 100 has a function that complies with consumables setting for performing consumables saving printing, from the capability information relating to the image forming apparatus 100, which has been acquired in step S1107. If the print processing management unit 501 determines that the image forming apparatus 100 has the function that complies with the consumables setting (YES in step S1113), the processing proceeds to step S1114.

In step S1114, the print processing management unit 501 instructs the print data generation unit 508 to generate print setting information for implementing the function that complies with the consumables setting in the image forming apparatus 100 (e.g., print setting information including information representing an instruction to perform consumables saving printing). The image forming apparatus 100 performs processing relating to the consumables, so that electronic data to be printed need not particularly be subjected to special processing. More specifically, if the electronic data to be printed is data having a PDF format or the like, the print setting information is only generated in step S1114, and registered original electronic data is directly used as print data. By the processing, the print data generation unit 508 generates the print setting information and the print data for performing the consumables setting. In step S1115, the print processing management unit 501 further sends the print setting information and the print data, which have been generated in step S1114, to the image forming apparatus 100, and the processing ends.

On the other hand, if the print processing management unit 501 determines that the image forming apparatus 100 does not have the function that complies with the consumables setting (NO in step S1113), the processing proceeds to step S1116. In step S1116, the print processing management unit 501 sends the print data and the print setting information, which have been generated in step S1104, to the image forming apparatus 100, and the processing ends.

If the print processing management unit 501 determines that there has been a response of the consumables setting cancel from the image forming apparatus 100 (YES in step S1112), the processing proceeds to step S1117. In step S1117, the print processing management unit 501 instructs the print data generation unit 508 to generate print setting information not including the consumables setting and print data that does not comply with the consumables setting. In response to the instruction, the print data generation unit 508 generates print setting information not including the consumables setting and print data not dependent on the consumables setting. If the electronic data to be printed, which has been registered from the instruction terminal 101, is data having a PDF format or the like, the registered original electronic data is directly used as print data, as described above. In step S1118, the print processing management unit 501 further sends the print setting information and the print data, which have been generated in step S1117, to the image forming apparatus 100, and the processing ends.

If the print processing management unit 501 determines that there has been a response of cancellation from the image forming apparatus 100 in step S1112, the processing ends.

A flow of processing from a request for print data to printing in the image forming apparatus 100 according to the second exemplary embodiment will be described below with reference to FIG. 12. FIG. 12 is a flowchart illustrating the processing from the request for the print data to the printing in the image forming apparatus 100 according to the second exemplary embodiment. A software module 400 performs the processing in the flowchart. More specifically, the processing is implemented when a CPU 201 in the image forming apparatus 100 rasterizes a program, which has been computer-readably recorded on a ROM 203 or a storage device 204, into a RAM 202 and executes the program.

In step S1201, a print processing management unit 401 in the image forming apparatus 100 waits for a print request (authentication request) from a user, and determines whether the authentication request is made (similar to step S701 illustrated in FIG. 7). If the print processing management unit 401 determines that the authentication request has been made (YES in step S1201), the processing proceeds to step S1202. In step S1202, the print processing management unit 401 performs device authentication processing (similar to step S702 illustrated in FIG. 7). In step S1203, the print processing management unit 401 then performs authentication by transferring authentication information read from an authentication card or authentication information keyed from a numeric keyboard, to the print server 103 to request authentication via a communication processing unit 402 (similar to step S703 illustrated in FIG. 7).

In step S1204, the print processing management unit 401 then receives an authentication processing result in the print server 103, and determines whether it has received a response of success of authentication (the print server 103 can be used) (similar to step S704 illustrated in FIG. 7). If the print processing management unit 401 determines that it has received a response of failure of authentication from the print server 103 (NO in step S1204), the print processing management unit 401 determines that the print server 103 cannot be used, and the processing ends.

On the other hand, if the print processing management unit 401 determines that it has received the response of success of authentication from the print server 103 (YES in step S1204), the processing proceeds to step S1205. In step S1205, the print processing management unit 401 acquires a capability of the image forming apparatus 100 and a status of consumables via a recording processing unit 403 and a status acquisition unit 404. The capability includes functions of the image forming apparatus 100, e.g., functions such as two-sided printing and stapling and a function that complies with consumables setting (a consumables saving function). The state includes the current status of the image forming apparatus 100, e.g., a remaining amount of consumables, the use or non-use of a printing function, and a paper jam.

In step S1206, the print processing management unit 401 then notifies information relating to the capability and the status, which have been acquired in step S1205, together with a print request, to the print server 103. More specifically, the print processing management unit 410 notifies a remaining amount of a color material and the capability of the image forming apparatus 100.

In step S1207, the print processing management unit 401 then confirms with the print server 103 whether print setting information and print data corresponding to a user who has been successful in the authentication in steps S1203 and S1204 are present or not present. If the print setting information and the print data do not exist (NO in step S1207), the processing ends.

On the other hand, if the print setting information and the print data exist (YES in step S1207), the processing proceeds to step S1208. In step S1208, the print processing management unit 401 acquires the print setting information and the print data, which have been generated by the print server 103. In step S1208, if the warning request (step S1111 illustrated in FIG. 11) is made from the print server 103 before the print processing management unit 401 acquires the print data, the print processing management unit 401 displays the warning screen 1001 as illustrated in FIG. 10 on a display unit in an input/output device 210 via an input/output processing unit 405, to give a warning. More specifically, the print processing management unit 401 warns the user that a printing result is affected, for example, becomes too light if it continuously performs printing. The print processing management unit 401 issues a print execution notification, a saving printing cancel notification, or a print cancel notification to the print server 103 when the user issues an instruction to select whether saving printing is performed, saving printing is cancelled, or printing is canceled. The print processing management unit 401 then acquires the print data and the print setting information from the print server 103. If the instruction to select the print cancel is issued, the processing ends (not illustrated).

In step S1209, the print processing management unit 401 then issues an instruction to perform printing based on the print setting information and the print data, which have been received from the print server 103, to perform the printing. If the consumables setting can be set in the image forming apparatus 100 and if the consumables setting is performed in the print setting, the print setting information includes an instruction to perform printing using a function that complies with the consumables setting in the image forming apparatus 100. When the printing is completed, the processing ends.

As described above, according to the second exemplary embodiment, the effect of the first exemplary embodiment is obtained while appropriate print data can be transmitted from a server and printed according to the capability of the image forming apparatus 100. If the consumables setting can be set in the image forming apparatus 100, and if the consumables setting is performed in the print setting, for example, print data to be printed using the function that complies with the consumables setting in the image forming apparatus 100 is generated and transmitted by the print server 103. The function that complies with the consumables setting in the image forming apparatus 100 enables printing as saving a used amount of consumables while reducing a deterioration in image quality in consideration of an image formation characteristic. If printing is performed by saving the used amount of the consumables, the deterioration in image quality can be generally more reduced when printing is performed using a function that complies with the consumables setting in the image forming apparatus 100, compared with a case where printing is performed using print data having a low density that complies with the consumables setting generated by the print server 103.

FIG. 11 illustrates a configuration in which the print data and the print setting information are generated according to the consumables setting in steps S1103 to S1105. However, print data and print setting information may also be generated based on consumables setting, a status of consumables, and the presence or non-presence of cancel of consumables setting, and the presence or non-presence of a function that complies with consumables setting on the side of the image forming apparatus 100 immediately before steps S1114 and S1116 and immediately before steps S1117 and S1119, respectively, without performing steps S1103 to S1105.

In the first exemplary embodiment, if consumables setting is performed, print data by which a used amount of consumables can be saved, is generated according to the consumables setting (i.e., print data itself is processed). However, if the image forming apparatus 100 has a print setting function, similar to the second exemplary embodiment, print data may not be processed, and print setting information including information representing an instruction to perform the saving printing may be generated.

A configuration of various types of data and its content are not limited to the above-described, and may be varied depending on uses and purposes. While one exemplary embodiment has been described above, the present invention can include an exemplary embodiment as a system, a device, a method, a program, or a storage medium, for example. More specifically, the present invention may be applied to a system including a plurality of devices, or may be applied to an apparatus including one device. All combinations of the above-mentioned exemplary embodiments are included in the present invention.

As described above, according to the exemplary embodiments of the present invention, a function of a consumables saving application that has been conventionally employed on the client side can be implemented by a printer driver on the server side, and a printing result considering a status of a device (an image forming apparatus) can be output. In a pull print system, a status of the image forming apparatus cannot be grasped until a print request is generated. Therefore, an appropriate output result can be obtained in consideration of a status of the image forming apparatus during printing, as a user demands in a consumables saving print request. Therefore, even if the consumables saving print request is made while a remaining amount of consumables in the image forming apparatus is small, an effect on printing that an image becomes too light due to a shortage of the consumables, for example, can be suppressed.

### Other Embodiments

The present invention is also implemented by performing the following processing. Software (a program) for implementing a function of the above-mentioned exemplary embodiment is supplied to a system or an apparatus via a network or various types of recording media, and a computer (or a CPU, an MPU, etc.) in the system or the apparatus reads out the program and executes the program. The present invention may be applied to a system including a plurality of devices, or may be applied to an apparatus including one device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-262324 filed Nov. 25, 2010, which is hereby incorporated by reference herein in its entirety.

What is claimed is:

1. A print system comprising a server, and an image forming apparatus configured to perform print processing of print data, wherein
the server includes:
a storage unit configured to store data registered from an external apparatus;
a generation unit configured to generate print data by processing the data to save the used amount of the color material during the print processing in the image forming apparatus, when saving printing which saves a used amount of a color material is set;
a first sending unit configured to send the print data generated by the generation unit to the image forming apparatus in response to a first request to acquire information including print data and print setting information from the image forming apparatus; and
a second sending unit configured to send the data stored by the storage unit before the processing by the generation unit is performed, to the image forming apparatus again in response to a second request to acquire print data and print setting information, by which the saving printing is not performed, from the image forming apparatus, and
the image forming apparatus includes:
a first request unit configured to make the first request to the server in response to an instruction from an operation unit;
a detection unit configured to detect a remaining amount of the color material used for the print processing in the image forming apparatus;
a determination unit configured to determine, when the information acquired in response to the first request includes at least one of print data and print setting information for the saving printing performed by saving the used amount of the color material, whether a printing result obtained on the basis of the print data and the print setting information is affected, according to the remaining amount of the color material detected by the detection unit;
a printing unit configured to perform print processing based on the print data and the print setting information included in the information acquired in response to the first request when the determination unit determines that the printing result is not affected;
a warning unit configured to warn the user when the determination unit determines that the printing result is affected; and
a second request unit configured to make the second request to the server, when the user issues an instruction to cancel the setting of the saving printing after the warning by the warning unit,
wherein the printing unit performs print processing based on the acquired print data and print setting information, when it has acquired the print data and the print setting information, by which the saving printing is not performed in response to the second request.

2. A printer comprising:
a first request unit configured to make a first request to acquire information including print data and print setting information to a server in response to an instruction from an operation unit;
a detection unit configured to detect a remaining amount of a color material used for print processing in the printer;
a determination unit configured to determine whether a printing result obtained on the basis of the print data and the print setting information is affected, according to the remaining amount of the color material, which has been detected by the detection unit when information acquired in response to the first request includes at least one of print data and print setting information for saving printing performed by saving a used amount of the color material;
a printing unit configured to perform print processing based on the print data and the print setting information included in the information acquired in response to the first request when the determination unit determines that the printing result is not affected;
a warning unit configured to warn a user when the determination unit determines that the printing result is affected; and
a second request unit configured to make a second request to the server to acquire print data and print setting information, by which the saving printing is not performed, when the user issues an instruction to cancel setting of the saving printing after the warning by the warning unit;
wherein the printing unit performs print processing based on the acquired print data and print setting information, when it acquires the print data and the print setting information, by which the saving printing is not performed in response to the second request.

3. The printer according to claim 2, wherein the warning unit warns that the printing result may be affected when the saving printing is performed, and urges the user to issue an instruction to select whether the setting of the saving printing is cancelled or the saving printing is performed.

4. The printer according to claim 2, wherein the print data for the saving printing is data processed to save the used amount of the color material by the server.

5. The printer according to claim 2, wherein
the print setting information for the saving printing includes the setting of the saving printing, and
the printing unit performs printing by saving the used amount of the color material, when the print setting information includes the setting of the saving printing.

6. The printer according to claim 2, wherein the saving printing can be set when the data used for the print processing is registered in the server.

7. A printer comprising:
a request unit configured to request print data and print setting information to a server in response to an instruction from an operation unit;
a detection unit configured to detect a status of the printer relating to print processing;
a warning unit configured to display a warning relating to a printing result of the print data based on the status of the image forming apparatus, which has been detected by the detection unit;
a cancel notification unit configured to notify the server that it has been instructed to cancel the setting of the saving printing when a user issues an instruction to cancel setting of saving printing included in the print setting information after the warning by the warning unit; and
a printing unit configured to perform printing by acquiring the print data and the print setting information that does not include the setting of the saving printing, which are sent from the server.

8. The printer according to claim 7, wherein the warning by the warning unit is displayed based on a warning request received as a response from the server after sending to the server the status of the printer, which has been detected by the detection unit.

9. A server that can communicate with an image forming apparatus, the server comprising:
a storage unit configured to store data registered from an external apparatus;
a generation unit configured to generate print data by processing the data to save a used amount of the color material during print processing in the image forming apparatus when saving printing performed by saving the used amount of a color material is set;
a first sending unit configured to send the print data generated by the generation unit to the image forming apparatus in response to a request from the image forming apparatus; and
a second sending unit configured to send to the image forming apparatus again the data stored by the storage unit before the processing is performed by the generation unit, in response to a request to cancel the setting of the saving printing from the image forming apparatus.

10. A printing method in a printing system comprising a server, and an image forming apparatus configured to perform print processing of print data, wherein
the printing method in the server comprises:
storing data registered from an external apparatus in a storage device;
generating print data by processing the data to save the used amount of the color material during the print processing in the image forming apparatus, when the saving printing performed by saving a used amount of a color material is set;
sending the generated print data to the image forming apparatus in response to a first request to acquire information including print data and print setting information from the image forming apparatus; and
sending the data stored by the storage device before the processing is performed, to the image forming apparatus again in response to a second request to acquire print data and print setting information, by which the saving printing is not performed, from the image forming apparatus, and
the printing method in the image forming apparatus comprises:
making the first request to the server in response to an instruction from an operation unit;
detecting a remaining amount of the color material used for the print processing in the image forming apparatus;
determining, when the information acquired in response to the first request includes at least one of print data and print setting information for the saving printing performed by saving the used amount of the color material, whether a printing result obtained on the basis of the print data and the print setting information is affected, according to the detected remaining amount of the color material; and
warning a user when it is determined in the determining that the printing result is affected; and
making the second request to the server when an instruction to cancel the setting of the saving printing is issued from the user after the warning,
wherein print processing is performed based on the print data and the print setting information included in the information acquired in response to the first request, when it is determined in the determining that the printing result is not affected, and
wherein print processing is performed based on the acquired print data and print setting information, when the print data and the print setting information, by which the saving printing is not performed, have been acquired in response to the second request.

11. A method in a printer, comprising:
making a first request to acquire information including print data and print setting information to a server in response to an instruction from an operation unit;
detecting a remaining amount of a color material used for print processing in the printer;
determining whether a printing result obtained on the basis of the print data and the print setting information is affected, according to the detected remaining amount of the color material, when information acquired in response to the first request includes at least one of print data and print setting information for saving printing performed by saving a used amount of the color material;
warning a user when it is determined in the determining that the printing result is affected; and
making a second request to the server to acquire print data and print setting information, by which the saving printing is not performed, when an instruction to cancel setting of the saving printing is issued from the user after the warning,
wherein print processing is performed, when it is determined in the determining that the printing result is not affected, based on the print data and the print setting information included in the information acquired in response to the first request, and
wherein print processing is performed based on the acquired print data and print setting information, when the print data and the print setting information, by which the saving printing is not performed, are acquired in response to the second request.

12. A method in a printer, comprising:
requesting print data and print setting information to a server in response to an instruction from an operation unit;
detecting a status of the printer relating to print processing;
displaying a warning relating to a printing result of the print data based on the status of the printer, which has been detected in the detecting;
notifying the server that the instruction to cancel the setting of the saving printing has been issued, when an instruction to cancel setting of saving printing included in the print setting information is issued from a user after the warning; and
performing printing by acquiring the print data and the print setting information that does not include the setting of the saving printing, which are sent from the server.

13. A method in a server that can communicate with an image forming apparatus, the method comprising:
storing data registered from an external apparatus in a storage device;
generating print data by processing the data to save a used amount of the color material during printing in the image forming apparatus, when saving printing performed by saving the used amount of a color material is set;
sending the print data generated in the generating to the image forming apparatus in response to a request from the image forming apparatus; and
sending to the image forming apparatus again the data stored by the storage unit before the processing is performed in the generating, in response to a request to cancel the setting of the saving printing from the image forming apparatus.

14. A computer readable storage medium on which is stored a computer program for making a computer execute a method for a printer, the method comprising:
making a first request to acquire information including print data and print setting information to a server in response to an instruction from an operation unit;
detecting a remaining amount of a color material used for print processing in the printer;
determining whether a printing result obtained on the basis of the print data and the print setting information is affected, according to the detected remaining amount of the color material, when information acquired in response to the first request includes at least one of print data and print setting information for saving printing performed by saving a used amount of the color material; and
warning a user when it is determined in the determining that the printing result is affected; and
making a second request to the server to acquire print data and print setting information, by which the saving printing is not performed, when an instruction to cancel the setting of the saving printing is issued from the user after the warning,
wherein print processing is performed, when it is determined in the determining that the printing result is not affected, based on the print data and the print setting information included in the information acquired in response to the first request, and
wherein print processing is performed based on the acquired print data and print setting information, when the print data and the print setting information, by which the saving printing is not performed, are acquired in response to the second request.

15. A computer readable storage medium on which is stored a computer program for making a computer execute a method for a printer, the method comprising:
requesting print data and print setting information to a server in response to an instruction from an operation unit;
detecting a status of the printer relating to print processing;
displaying a warning relating to a printing result of the print data based on the status of the image forming apparatus, which has been detected in the detecting;
notifying the server that the instruction to cancel the setting of the saving printing has been issued, when an instruction to cancel setting of saving printing included in the print setting information is issued from a user after the warning; and
performing printing by acquiring the print data and the print setting information that does not include the setting of the saving printing, which are sent from the server.

16. A computer readable storage medium on which is stored a computer program for making a computer execute a method for a server communicating with an image forming apparatus, the method comprising:
storing data registered from an external apparatus in a storage device;
generating print data by processing the data to save a used amount of a color material during printing in the image forming apparatus, when saving printing performed by saving the used amount of a color material is set;
sending the print data generated in the generating to the image forming apparatus in response to a request from the image forming apparatus; and
sending to the image forming apparatus again the data stored by the storage device before the processing is performed in the generating in response to a request to cancel the setting of the saving printing from the image forming apparatus.
